(19) United States
(12) Patent Application Publication
(10) Pub. No.: US 2018/0319408 A1
(43) Pub. Date: Nov. 8, 2018

(54) METHOD FOR OPERATING A VEHICLE

(71) Applicant: Robert Bosch GmbH, Stuttgart (DE)

(72) Inventor: Dieter HOETZER, Markgroeningen (DE)

(73) Assignees: Robert Bosch GmbH, Stuttgart (DE); Robert Bosch GmbH, Stuttgart (DE)

(21) Appl. No.: 15/773,419

(22) PCT Filed: Nov. 7, 2016
(86) PCT No.: PCT/EP2016/076827

§ 371 Date: May 3, 2018

(30) Foreign Application Priority Data
Dec. 8, 2015 (DE) 10 2015 224 555.1

(51) Int. Cl. B60W 50/14; G05D 1/00

(52) U.S. Cl. CPC B60W 50/14; G05D 1/0061; G05D 2201/0213; B60W 2050/146; B60W 2540/02; B60W 2540/22

(57) ABSTRACT

A method for operating a motor vehicle using an apparatus to prompt the driver for an interaction, the motor vehicle having the ability to be operated at least in one operating mode with semi-autonomous or autonomous vehicle guidance and in an operating mode with vehicle guidance controlled by the driver, a reaction of the driver with respect to a prompt for an interaction being checked during operation of the semi-autonomous or autonomous vehicle guidance. The method is includes that a viewing direction of the driver and/or a vocal utterance by the driver is/are considered when checking the reaction of the driver.

### FIELD

The present invention relates to a method for operating a motor vehicle using an apparatus to prompt the driver for an interaction, the motor vehicle having the ability to be operated at least in one operating mode with semi-autonomous or autonomous vehicle guidance and in an operating mode with vehicle guidance controlled by the driver, a reaction of the driver with respect to a prompt for an interaction being checked during operation of the semi-autonomous or autonomous vehicle guidance. The present invention also relates to an apparatus suitably equipped to carry out the method, a driver assistance system, a computer program as well as a storage device.

### BACKGROUND INFORMATION

German Patent Application No. DE 10 2013 206 212 A1 describes a method for controlling a vehicle with temporarily autonomous vehicle guidance, as well as a control device. In the case of a method for controlling a vehicle, with the vehicle being able to be operated at least in an operating mode with autonomous vehicle guidance and in a driver-controlled operating mode, in the operating mode with autonomous vehicle guidance, the alertness of the driver is monitored in order to ensure a takeover of the control responsibility by the driver possibly becoming necessary within a predetermined takeover time window. To that end, from time to time, possibly even many times, cognitively demanding tasks are set for the driver via a man-machine interface, and the alertness of the driver is determined from the response to them. The alertness of the driver is effectively maintained by the cognitively demanding task, and the time for perceiving system messages, especially prompts for the takeover of the control responsibility by the driver, is improved, if such system messages are overlaid on the display on which the tasks are also displayed.

In today's production vehicles, driving environment sensor systems (radar, video, etc.) are installed, which assist the driver in his driving task. Thus, the present-day E-class offers the Distronic Plus with steering assist and Stop & Go Pilot. Consequently, under certain preconditions (e.g., more visible lines, large radii of curve) the driver is able to drive in automated fashion for a defined time interval without gas-pedal/brake-pedal and steering-wheel interventions (see image 1, left). The present functional implementation entails that, especially on straight turnpike stretches, the driver must move the steering wheel briefly approximately every 10 seconds, in order for the function to be constantly active. After this time, first of all, a suitable warning symbol appears in the viewing area of the driver, which prompts the driver to move the steering wheel. If this is not done, next, a warning tone sounds and the function is deactivated. However, the monitoring mechanism may easily be circumvented, e.g., by placing a half-filled drinking bottle on the steering wheel. In this case, the moving mass simulates the steering interventions of a driver, and the originally usefully intended monitoring is overridden.

German Patent Application No. DE 19 838 818 A1 describes a gaze-controlled stop-and-go automatic system in motor vehicles. A motor vehicle in stop-and-go traffic is causatively controlled by the deliberate turning of the driver's gaze ahead toward the roadway, without the utilization of hands and feet. Via the central control unit, the complex sensors and actuator units of the on-board system permit a semi-automatic crawler gear, provided the stop-and-go button was consciously activated, the camera of the optical sensing system sees that the gaze of the driver is directed ahead toward the roadway, and all other boundary conditions are safely satisfied.

### SUMMARY

An example method in accordance with the present invention advantageously permits greater comfort for the vehicle driver as well as increased safety during semi-autonomous or autonomous vehicle guidance. This is made possible according to the present invention as described herein. Further refinements of the present invention are described herein.

The method of the present invention for operating a motor vehicle using an apparatus to prompt the driver for an interaction, the motor vehicle having the ability to be operated at least in one operating mode with semi-autonomous or autonomous vehicle guidance and in an operating mode with vehicle guidance controlled by the driver, a reaction of the driver with respect to a prompt for an interaction being checked during operation of the semi-autonomous or autonomous vehicle guidance, is characterized in that a detected viewing direction of the driver and/or a detected vocal utterance by the driver is/are taken into consideration when checking the reaction of the driver.

This is understood to mean that a reaction of the driver is checked during operation of the vehicle with semi-autonomous or autonomous vehicle guidance. Hereinafter, in particular, the term “autonomous” is used, which is intended to include the semi-autonomous vehicle guidance, that is, the semi-autonomous operation of a motor vehicle, as well. A check of the reaction of the driver may be used for an initial activation or for a continuation of the autonomous vehicle guidance. The prompt for the interaction as well as the checking of the reaction in terms of a continuation of the vehicle guidance may have as its objective a check of a possible takeover capability of the vehicle by the driver. Moreover, within the context of the check, it may be considered, for example, whether a reaction takes place at all and/or whether a generally defined reaction takes place and/or whether a reaction applicable specifically to the respective interaction prompt takes place and/or whether the reaction takes place within a defined period of time and/or how fast the reaction takes place.

At the same time, a check may advantageously include an evaluation and analysis of data which were acquired by further devices (e.g., a passenger-compartment camera or a microphone) and/or other suitable methods. Naturally, the check may also include monitoring of the driver and data acquisition.

For example, an awareness on the part of the driver with regard to an interaction prompt as well as an acknowledgment of the awareness are regarded as reaction of the driver. In particular, non-contact interactions are understood as reaction. Therefore, for example, the following are possible as reactions: visual reactions, defined head movements or gestures, specific viewing direction and focusing of points, e.g., interaction prompts, verbal utterances, other reactions which may be regarded as awareness and confirmation of the interaction prompt, without explicitly having to use switches, knobs, operator control elements, e.g., steering wheel, etc. The described consideration of a viewing direction and/or a vocal utterance by the driver is/are suitable in order to be able to determine such a reaction technically.

For example, comfort for the driver may thereby be increased, especially in comparison to the related art. By taking such factors into consideration, it is possible to dispense with a burdensome interaction of the driver, e.g., by movement of the steering wheel or inputs with the aid of haptic operator-control elements. In addition, the required eye movements and vocal utterances are very efficient measures, since they may be carried out quickly by the driver. Moreover, they appear to be effective means for keeping stress on the driver low. The method is therefore a suitable compromise between availability of the autonomous vehicle operation and monitoring function of the driver.

Furthermore, a misuse of possibilities in the case of the bypassing of the monitoring devices of the related art—as could take place, for example, in response to the prompt for the “steering-wheel motion”, by a drinking bottle tied to the steering wheel—may be reduced to a great extent and largely prevented.

Safety during autonomous vehicle guidance may be increased by such means, as well. This is based on the fact that even during autonomous vehicle guidance, a steering intervention by the driver is taken into account and implemented to some extent. A steering-wheel motion—as called for in part in the related art—may therefore result in harm to the vehicle and possibly to further road users, especially given strong execution by the driver and high velocity.

Moreover, the means described make it possible to prevent the fulfillment of an interaction prompt from being confirmed mistakenly if for example, a steering-wheel motion by the driver coincides by chance with the request, as is also possible in the case of weariness or momentary drowsiness.

In one advantageous specific embodiment, the method is characterized in that the semi-autonomous or autonomous vehicle guidance is maintained if the reaction of the driver with respect to a prompt for an interaction corresponds to a defined first condition.

This is understood to mean that a first condition is defined which describes, for example, how the reaction of the driver must be in order to maintain the autonomous vehicle guidance. In this case, naturally a specific reaction may be defined, to which the actual reaction of the driver must correspond. Moreover, advantageously a first time interval may also be defined, within which the driver must execute the defined reaction. In an alternative implementation, it is also possible that multistage reactions of the driver are describable by this condition. That is, the driver must carry out not only one specific reaction, but rather, for example, a cascade of reactions. Advantageously, it may thus be checked cyclically, for instance, whether the driver is available as fallback. Consequently, the motor vehicle is operated advantageously in a manner that the autonomous vehicle guidance only continues to be implemented if the driver provides the desired reaction. Furthermore, this may be understood to mean that a change from the autonomous vehicle guidance to the vehicle guidance controlled by the driver is activated if the defined reaction is not detected.

In one possible refinement, the method is characterized in that the prompt for the interaction is implemented as a visually displayed interaction prompt.

This means that the method provides for displaying the prompt for the interaction visually to the driver. For this, a display device is necessary in the vehicle. A display already present, e.g., instrument cluster, head-up display, display of the center console, may advantageously be used. The visual representation may be implemented in various ways. For example, symbols already available today and used for such a prompt may be employed. Of course, new elements may also be introduced for this purpose. In particular, graphic symbols or visually displayed catchwords or prompts seem to be relevant for this. Alternatively, graphic animations or moving elements may also be used in order, for example, to check a capability of reaction and/or a following of the eyes Advantageously, the driver is only slightly adversely affected by a visually displayed interaction prompt. Good user acceptance may thereby be achieved, especially in the case of a high number of prompts.

Furthermore, the prompt may be implemented as a visually displayed interaction prompt in combination with an acoustic interaction prompt. In one advantageous alternative, the prompt for the interaction may also be provided as an acoustic signal or as a verbal prompt. The risk that the prompt will not be perceived may be reduced advantageously by an acoustic prompt.

In one preferred development, the method is characterized in that as first condition, it is provided that
the viewing direction of the driver is directed toward the visually displayed interaction prompt and/or
the vocal utterance by the driver corresponds to a defined, verbally spoken command.

By this it is understood that the autonomous vehicle guidance is maintained if the driver looks at the visually displayed interaction prompt. In this context, in a first analysis, it is assumed that the driver has perceived the interaction prompt if an interaction prompt is output visually and the driver looks at it. In an alternative refinement, the autonomous vehicle guidance is maintained if the driver voices a defined command. In these cases, advantageously, a takeover capability of the driver may be assumed in an easy manner and with sufficient certainty, and the autonomous vehicle guidance continues to be maintained.

In one advantageous further development, the method is characterized in that the semi-autonomous or autonomous vehicle guidance is maintained if the reaction of the driver with respect to a prompt for an interaction additionally corresponds to a defined second condition, in particular, the second condition representing a confirmation by the driver that he is aware of the interaction prompt.

This is understood to mean that the autonomous vehicle guidance is maintained only if the reaction of the driver satisfies both the described first condition and a defined second condition. The correct viewing direction as well as the correct verbal command were defined as first condition, upon whose fulfillment, it is assumed that the driver is aware of the prompt. The second condition for the reaction now permits a confirmation of this assumed awareness. Particularly in the case of a sweeping glance by the driver, a situation could occur in which the eye of the driver may run briefly over a visually displayed interaction prompt, without the driver actually perceiving it. The consideration of a second condition therefore further reduces the possibility of a false assumption of awareness, and therefore increases the likelihood that the reaction of the driver corresponds to the defined reaction.

In one possible development, the method is characterized in that as second condition, it is provided that
a defined dwell time of the viewing direction of the driver toward the displayed interaction prompt is determined and/or
a defined movement of the driver is ascertained, especially if a one-time or repeated blinking of an eye of the driver is detected, and/or
a defined vocal utterance by the driver is ascertained, especially if it is determined that the driver has voiced a defined verbal command.

By this it is understood that the autonomous vehicle guidance is maintained if, for example, the viewing direction of the driver is directed toward the visually displayed interaction prompt, and the gaze of the driver remains on the visually displayed interaction prompt for a defined period of time. It is thus advantageously possible to increase the certainty that the driver has perceived the prompt, and therefore the reaction of the driver actually corresponds to the defined reaction.

In an alternative embodiment, to confirm the awareness, it may be provided that the driver must execute a specific motion. For example, a nodding of the head or a gesture with the fingers or the hand may be provided for this purpose. In particular, blinking of the eyelid by the driver seems advantageous in this case. This may be defined as a one-time or repeated blinking. In this manner, certainty may be further increased, without unduly stressing the driver.

In a further alternative embodiment, to confirm the perception, it may be provided that the driver must utter a specific voice command. Notably, any combination of viewing direction and voice command is possible here. Certainty may advantageously be increased in this manner, as well. Furthermore, a combination of viewing direction and voice command may be accomplished not only very easily but also very quickly and without great effort for the driver.

In one preferred specific embodiment, the method is characterized in that a warning to the driver ensues if no reaction of the driver with respect to the interaction prompt is detected within a defined first, or third period of time, or the reaction of the driver does not correspond to the defined first and/or second condition, in particular,
a warning symbol being displayed visually and/or
the interaction prompt being amplified or intensified.

By this is understood that in addition to the interaction prompt, further information is output, namely, a warning. The warning ensues if the driver does not react to the interaction prompt or the reaction does not correspond to the defined first or second condition. In this context, the defined first period of time relates to the fulfillment of the defined first condition. The defined third period of time relates to the fulfillment of the defined second condition. The two periods of time may be identical, but do not have to be. The warning may be output as a visual representation. Displays already present in the vehicle, such as the instrument cluster, the head-up display as well as the display of the center console are again suitable for this purpose. It may be the same display as for the interaction prompt, however this is not imperative. By the use of a warning, an intermediate stage may advantageously be inserted between the interaction prompt and the deactivation of the autonomous vehicle guidance. Moreover, the definition of the warning may more strongly demand the attention of the driver.

In one advantageous further development, the method is characterized in that the semi-autonomous or autonomous vehicle guidance is deactivated if no reaction of the driver with respect to the warning is detected within a defined second, or fourth period of time, or the reaction of the driver does not correspond to the defined first and/or second condition.

By this is to be understood that the autonomous vehicle guidance is deactivated if the driver does not react to the interaction prompt or the reaction does not correspond to the defined first or second condition. In this context, the defined second period of time relates to the fulfillment of the defined first condition. The defined fourth period of time relates to the fulfillment of the defined second condition. The two periods of time may be identical, but do not have to be.

In one preferred implementation, the method is characterized in that the semi-autonomous or autonomous vehicle guidance is maintained if
the reaction of the driver with respect to the interaction prompt corresponds to the defined first and/or second condition and/or
the reaction of the driver is detected within a defined first, or third period of time starting from the interaction prompt and/or
the reaction of the driver is detected within a defined second, or fourth period of time starting from the warning.

This is understood to mean that the autonomous vehicle guidance is not discontinued, but rather is able to be maintained if the defined reaction of the driver takes place in the cyclical interaction prompts. In this context, maintenance is advantageously possible over a time interval of any length as desired, so long as all other criteria for it are satisfied.

In addition, the autonomous vehicle guidance may be maintained if a behavior of the driver is identified which corresponds to a predefined behavior and, for example, represents an unequivocal takeover capability. In this case, for instance, an intervention in the vehicle control, especially steering interventions as well as braking maneuvers may be defined.

In one preferred further development, the method is characterized in that a return message to the driver ensues if the reaction of the driver corresponds to the defined condition, in particular, the return message taking the form of a visually displayed return message.

This means that the driver receives a return message as to whether his reaction corresponds to the defined reaction, that is, whether his reaction is sufficient to maintain the automatic vehicle guidance. Thus, an unexpected discontinuation may advantageously be avoided. This also avoids the situation of the driver possibly focusing for an unnecessarily long period of time on the interaction prompt, which could reduce the acceptance of the function. Furthermore, the driver may learn through the return message how his reaction is perceived by the system and if it may be necessary to adjust it in a way that it is recognized as defined reaction by the system.

In one advantageous development, the method is characterized in that the viewing direction of the driver is determined by a passenger-compartment camera and/or the vocal utterance of the driver is detected by a microphone.

This is understood to mean that a passenger-compartment camera is used for determining the viewing direction of the driver. In so doing, advantageously a passenger-compartment camera may be used which is already installed in the vehicle. Naturally, the viewing direction of the driver may also be ascertained by alternative approaches. In particular, it is provided to use microphones already installed in the vehicle to pick up the vocal utterances of the driver.

In addition, a driver assistance system for a motor vehicle is provided with an apparatus to prompt the driver for an interaction, the motor vehicle having the ability to be operated at least in one operating mode with semi-autonomous or autonomous vehicle guidance and in an operating mode with vehicle guidance controlled by a driver, a reaction of the driver with respect to a prompt for an interaction being checked during operation of the semi-autonomous or autonomous vehicle guidance. According to the present invention, the driver assistance system is characterized in that the driver assistance system has means and is set up to carry out the described method during intended usage.

This is to be understood as a driver assistance system by which the comfort of the driver as well as safety during autonomous vehicle guidance may be increased through the use of the described method

In this context, the driver assistance system may be a system for the autonomous or semi-autonomous vehicle guidance, a reaction of the driver with respect to a prompt for an interaction being checked for the operation of the semi-autonomous or autonomous vehicle guidance, characterized in that a viewing direction of the driver and/or a vocal utterance by the driver is/are taken into consideration when checking the reaction of the driver. In addition, one or more of the further method aspects may be implemented in it, as well.

For example, the method may be implemented in software or hardware or in a mixed form of software and hardware, e.g., in a control device. The approach presented here also provides an apparatus which is designed to carry out, control or implement the steps of a variant of a method presented here, in suitable devices. The object of the present invention may be achieved quickly and efficiently by this variant of the invention in the form of an apparatus, as well.

In the present case, such an apparatus may be understood to be an electrical device which processes sensor signals and outputs control and/or data signals as a function thereof. The apparatus may have an interface which may be implemented in hardware and/or software. If implemented in hardware, the interfaces may be part of what is referred to as a system ASIC, for example, that includes a wide variety of functions of the apparatus. However, it is also possible that the interfaces are separate integrated circuits or are made up at least partially of discrete components. If implemented in software, the interfaces may be software modules which are present on a microcontroller, for example, in addition to other software modules.

Of advantage is also a computer-program product or computer program having program code that may be stored on a machine-readable carrier or storage medium such as a semiconductor memory, a hard disk memory or an optical memory and is used to carry out, implement and/or control the steps of the method according to one of the specific embodiments described above, especially when the program product or program is executed on a computer or an apparatus.

It should be pointed out that the features indicated individually in the description may be combined with each other in any technically meaningful manner and illustrate further embodiments of the present invention. Additional features and utility of the present invention are derived from the description herein of exemplary embodiments with reference to the figures.

### BRIEF DESCRIPTION OF THE DRAWINGS

FIG. 1 shows a schematic representation of a vehicle having an assistance system in which the method is implemented.

FIG. 2 shows a schematic representation of the method.

### DETAILED DESCRIPTION OF EXAMPLE EMBODIMENTS

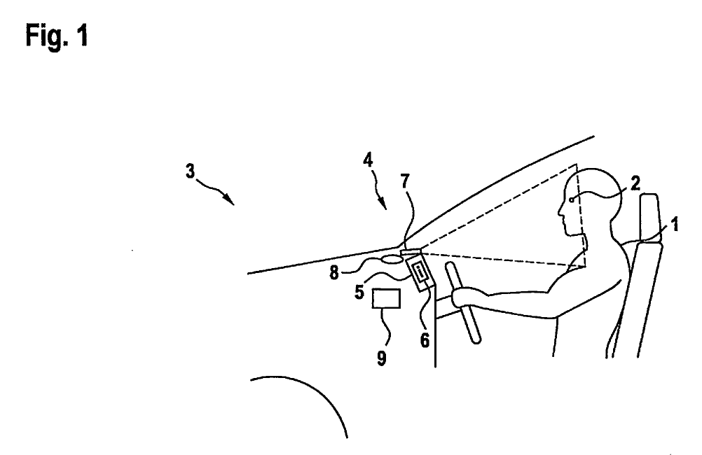

FIG. 1 shows an exemplary realization of a vehicle 3 having a suitable driver assistance system 4. Vehicle 3 may be operated in an operating mode with semi-autonomous vehicle guidance as well as in an operating mode with vehicle guidance controlled by driver 1. The semi-autonomous operating mode is carried out when driver assistance system 4 is activated. After a defined time has passed, the capability of driver 1 to take over is checked. For this, with the aid of specific information 6, e.g., a visual interaction prompt, driver 1 is prompted for an interaction. Information 6, i.e., the prompt for the interaction, is conveyed to driver 1 via a suitable apparatus 5, e.g., a display. In addition, the reaction of driver 1 to displayed interaction prompt 6 is checked via a passenger-compartment sensor system 7, 8. For example, a passenger-compartment camera 7 may be used as sensor system, by which driver 1 is monitored. Eyes 2 of driver 1 may be observed, for instance, and the viewing direction of driver 1 may be deduced from that. In this manner, it may be checked, for example, whether the driver is looking at interaction prompt 6 and is perceiving it. In addition to or as an alternative to a visual check of such a reaction of driver 1 to an interaction prompt 6, a vocal utterance by driver 1 may also be monitored by a microphone 8, for example. It may thereby be checked, for instance, whether driver 1 voices a defined verbal command in reaction to interaction prompt 6. Interaction prompt 6 and possible later warnings, as well as passenger-compartment sensor system 7, 8 may be controlled by one or more regulating or control devices 9. Likewise, the ascertained data may thus also be evaluated, and a system reaction with regard to the evaluated data may be carried out, for example, continuing to keep the (e.g., autonomous) operating mode active or shutting it down.

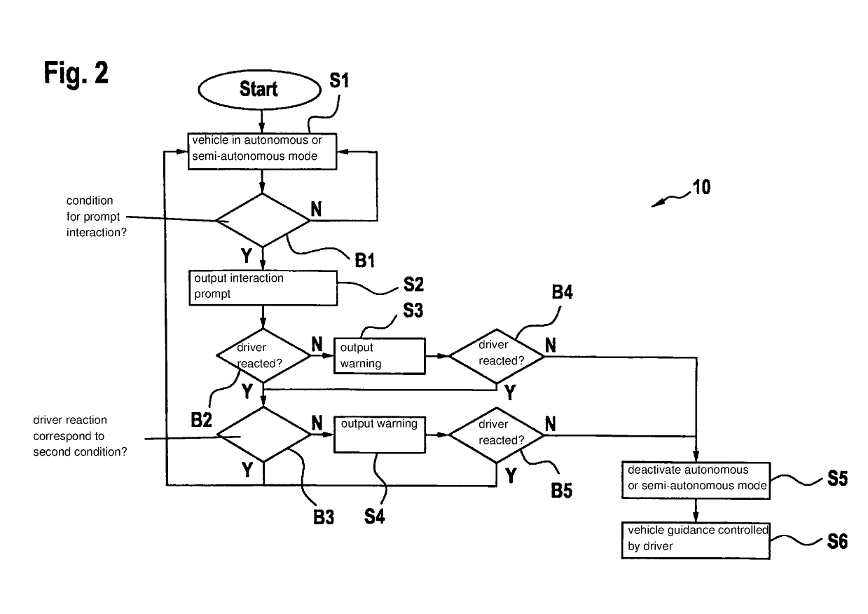

FIG. 2 shows a schematic representation of an exemplary method 10. The method is made up of various steps S, which in part are a function of decisions or conditions B. After the start of the method—in method step S1—the vehicle is in an operating mode with autonomous or semi-autonomous vehicle guidance. This type of vehicle guidance is carried out until condition B1 is satisfied. B1 describes the condition for a prompt for an interaction. For instance, such a condition may be a passage of time, that is, an elapsed period of time in which the vehicle is in an autonomous or semi-autonomous vehicle guidance, without the driver having intervened manually in it. Upon positive fulfillment of condition B1, an interaction prompt is output in a step S2. For example, this may take the form of a visual interaction prompt with the aid of a notice represented on a display to the driver.

Subsequently, in B2 it is checked whether the driver reacts or whether the reaction of the driver corresponds to a defined first condition. In addition, it is checked whether the reaction takes place within a defined first period of time. If B2 is decided positively, the method is continued. If B2 is decided negatively, in a next step S3, further information is output to the driver, especially a specific warning. Subsequent to the warning from S3, in B4, it continues to be checked whether the suitable reaction of the driver takes place, that is, whether the reaction of the driver corresponds to the defined first condition. In addition, it is checked whether the reaction takes place within a defined second period of time. If B4 is decided positively, the method is continued.

In addition, the method provides for a further condition B3. B3 checks whether the reaction of the driver corresponds to a second condition. Moreover, it is checked whether the reaction takes place within a defined third period of time. If B3 is decided positively, the method is continued. If B3 is decided negatively, in a next step S4, a notice ensues to the driver, especially a specific warning. Subsequent to the warning from S4, in B5, it continues to be checked whether the suitable reaction of the driver takes place, that is, whether the reaction of the driver corresponds to the defined second condition. In addition, it is checked whether the reaction takes place within a defined fourth period of time. If B5 is decided positively, the method is continued.

However, should it continue in B4 that no suitable reaction, or rather, no reaction of the driver is determined that corresponds to the defined first condition, in a step S5, the autonomous or semi-autonomous vehicle guidance is deactivated. In addition, should no suitable reaction, or rather, no reaction of the driver that corresponds to the defined second condition be determined in B5, the autonomous or semi-autonomous vehicle guidance is deactivated in a step S5. Naturally, such a deactivation may also be linked to a corresponding takeover prompt. In a last step S6, after the takeover, the vehicle guidance controlled by the driver is carried out.

1-15. (canceled)

16. A method for operating a motor vehicle, using an apparatus to prompt a driver for an interaction, the motor vehicle having the ability to be operated at least in one operating mode with semi-autonomous or autonomous vehicle guidance and in an operating mode with vehicle guidance controlled by the driver, the method comprising:
checking, during operation of the semi-autonomous or autonomous vehicle guidance, a reaction of the driver with respect to a prompt for an interaction;
wherein during the checking, taking into account at least one of a detected viewing direction of the driver, and a detected vocal utterance by the driver.

17. The method as recited in claim 16, wherein the semi-autonomous or autonomous vehicle guidance is maintained if the reaction of the driver with respect to a prompt for an interaction corresponds to a defined first condition.

18. The method as recited in claim 17, wherein the prompt for the interaction is implemented as a visually displayed interaction prompt.

19. The method as recited in claim 18, wherein the checking includes, as the first condition, at least one of the viewing direction of the driver is directed toward the visually displayed interaction prompt, and the vocal utterance by the driver corresponds to a defined, verbally spoken command.

20. The method as recited in claim 17, wherein the semi-autonomous or autonomous vehicle guidance is maintained if the reaction of the driver with respect to a prompt for an interaction additionally corresponds to a defined second condition, the second condition representing a confirmation by the driver that the driver is aware of the interaction prompt.

21. The method as recited in claim 20, wherein as the second condition, at least one of a defined dwell time of the viewing direction of the driver toward the displayed interaction prompt is determined, a defined movement of the driver is ascertained if a one-time or repeated blinking of an eye of the driver is detected, and a defined vocal utterance by the driver is ascertained if it is determined that the driver has voiced a defined verbal command.

22. The method as recited in claim 20, wherein a warning to the driver ensues if one of: (i) no reaction of the driver with respect to the interaction prompt is detected within a defined first, or third period of time, or (ii) the reaction of the driver does not correspond to at least one of the defined first condition and the defined second condition, the warning including at least one of visually displaying a warning symbol visually and amplifying the interaction prompt.

23. The method as recited in claim 22, wherein the semi-autonomous or autonomous vehicle guidance is deactivated if at least one of: (i) no reaction of the driver with respect to the warning is detected within a defined second, or fourth period of time, and (ii) the reaction of the driver does not correspond to at least one of the defined first condition and the defined second condition.

24. The method as recited in claim 22, wherein the semi-autonomous or autonomous vehicle guidance is maintained if at least one of: (i) the reaction of the driver with respect to the interaction prompt corresponds to at least one of the defined first condition and the defined second condition, (ii) the reaction of the driver is detected within a defined first, or third period of time starting from the interaction prompt, and (iii) the reaction of the driver is detected within a defined second, or fourth period of time starting from the warning.

25. The method as recited in claim 24, wherein a return message to the driver ensues if the reaction of the driver corresponds to the defined condition, the return message taking the form of a visually displayed return message.

26. The method as recited in claim 16, wherein at least one of: (i) the viewing direction of the driver is determined by a passenger-compartment camera, and (ii) the vocal utterance of the driver is detected by a microphone.

27. An apparatus for operating a motor vehicle, using an apparatus to prompt a driver for an interaction, the motor vehicle having the ability to be operated at least in one operating mode with semi-autonomous or autonomous vehicle guidance and in an operating mode with vehicle guidance controlled by the driver, the apparatus configured to:
check, during operation of the semi-autonomous or autonomous vehicle guidance, a reaction of the driver with respect to a prompt for an interaction;
wherein during the checking, taking into account at least one of a detected viewing direction of the driver, and a detected vocal utterance by the driver.

28. A driver assistance system for a motor vehicle, the motor vehicle having the ability to be operated at least in one operating mode with semi-autonomous or autonomous vehicle guidance and in an operating mode with vehicle guidance controlled by a driver, the driver assistance system comprising:
an apparatus to prompt the driver for an interaction;
a device to check a reaction of the driver with respect to a prompt for an interaction during operation of the semi-autonomous or autonomous vehicle guidance.

29. A non-transitory machine-readable storage medium on which is stored a computer program for operating a motor vehicle, using an apparatus to prompt a driver for an interaction, the motor vehicle having the ability to be operated at least in one operating mode with semi-autonomous or autonomous vehicle guidance and in an operating mode with vehicle guidance controlled by the driver, the computer program, when executed by a computer, causing the computer to perform:
checking, during operation of the semi-autonomous or autonomous vehicle guidance, a reaction of the driver with respect to a prompt for an interaction;
wherein during the checking, taking into account at least one of a detected viewing direction of the driver, and a detected vocal utterance by the driver.
